(19) United States
(12) Patent Application Publication
(10) Pub. No.: US 2026/0163071 A1
(43) Pub. Date: Jun. 11, 2026

(54) LOW-DIMENSIONAL TELLURIUM IODIDE PEROVSKITE STRUCTURE AND AN AQUEOUS ZINC BATTERY USING THE SAME

(71) Applicant: City University of Hong Kong, Hong Kong (HK)

(72) Inventors: Chunyi ZHI, Hong Kong (HK); Shixun WANG, Hong Kong (HK)

(21) Appl. No.: 18/977,877

(22) Filed: Dec. 11, 2024

(51) Int. Cl. H01M 10/26; H01M 50/105; H01M 50/44

(52) U.S. Cl. CPC H01M 10/26; H01M 50/105; H01M 50/44; H01M 2300/0002

(57) ABSTRACT

The present invention relates to a low-dimensional tellurium iodide perovskite structure. The low-dimensional structure, specifically an organic-inorganic hybrid benzyltriethylammonium tellurium iodide ((BzTEA)₂TeI₆), enables a highly efficient eleven-electron transfer process involving redox pairs of Cl⁰/Cl⁻, I⁺/I⁰/I⁻, and Te⁶⁺/Te⁴⁺/Te⁰/Te²⁻. This innovative perovskite structure confines both chalcogen and halogen elements, effectively mitigating the shuttle effect and enhancing stability by spatially restricting active species within the lattice. The Zn∥(BzTEA)₂TeI₆ battery with the (BzTEA)₂TeI₆ cathode exhibits a high capacity of at least 450 mAh g⁻¹_{Te/I} and a large energy density of 577 Wh kg⁻¹_{Te/I} at 0.5 A g⁻¹, with capacity retention up to 77% and 82% after 500 cycles at 1 A g⁻¹ and 3 A g⁻¹, respectively. The pouch cell having a capacity of 113 mAh further confirms the feasibility of the perovskite cathode. The present invention sheds light on the design of high-energy batteries based on chalcogen-halide perovskite cathodes with rich chemistry.

### FIELD OF THE INVENTION

The present invention generally relates to at least the fields of energy storage, materials science, and electrochemistry.

### BACKGROUND OF THE INVENTION

The demand for efficient and cost-effective energy storage solutions to handle intermittent renewable energy sources has sparked significant interest in functional perovskite materials. Low-dimensional metal-halide perovskites form a unique class of ionic crystals, including various oxide and halide structures that share similar octahedral characteristics. These perovskites utilize Van Der Waals forces, such as hydrogen bonds and halogen bonds, along with steric hindrance from A-site organics, to act as halogen reservoirs and mitigate the shuttle effect. This enables a three-electron transfer process. Owing to the abundance of oxygen vacancies, oxide perovskites with the ABO₃ structure—where A and B are divalent and tetravalent metallic cations, respectively—are recognized as promising candidates for applications in ferroelectricity, dielectrics, magnetism, and energy storage. Instead, halide perovskites (ABX₃, A is monovalent cation, B is divalent cation, and X is I, Br, or Cl) possess relatively narrower bandgaps due to the large difference in electronegativity between halogens and oxygen, thereby used for optoelectronic applications such as the light absorber and emissive layer in solar cells and light-emitting diodes, respectively.

The research on molecular-level low-dimensional (LD) crystals such as two-dimensional (2D), one-dimensional (1D), and zero-dimensional (0D) perovskites are advanced in the meanwhile due to demand for structural stability, some of which reflect deficient formation energy at ambient conditions being suitable for multifunctional purposes¹⁻³. However, the potential of the current low-dimensional metal-halide perovskites as conversion-type cathode materials remains limited. The LD organic-inorganic hybrid perovskites demonstrate a substantial quantum and dielectric confinement due to the breakdown of three-dimensional (3D) frameworks as the inclusion of insulating organic moieties. This special lattice ordering promotes improved structural stability and expanded bandgaps that bring out an exciting intersection of the halide and oxide perovskites' applications, including ferroelectricity and energy storage devices.

Unlike ancillary oxide perovskites that provide oxygen vacancies for metal-air batteries, halide perovskites perform as the halogen reservoir and restrain the shuttle effect by using Van Der Waals forces (hydrogen bonds and halogen bonds) and steric hindrance from A-site organics, eventually realizing a three-electron transfer process. However, those encouraging attempts to develop halide perovskite cathodes failed to avail the full range of perovskite materials given that the redox reaction of the B-site cations sits electrochemical inert during the conversion process (of halogens). This undermines the whole discharge capacity.

In this regard, replacing those noble B-site metal cations with tetravalent chalcogenide cations to construct chalcogen-halide octahedra is expected to offer full utilization of cathode materials and guarantee a reliable multiple electron transfer. Nevertheless, the high-valent hexavalent and tetravalent chalcogen cations are neither stable nor electrochemically active in aqueous electrolytes, causing irreversible redox processes in batteries.

Consequently, there is a need in the art to develop strategies that enhance the electrochemical activity of B-site metal cations in low-dimensional metal-halide perovskites.

### SUMMARY OF THE INVENTION

In light of the aforementioned challenges, to fully harness the capabilities of perovskite structures, the present invention provides a low-dimensional organic-inorganic hybrid benzyltriethylammonium tellurium iodide, (BzTEA)₂TeI₆, as cathode material and enables both X- and B-site elements to exhibit encouraging electrochemical activity through highly reversible chalcogen- and halogen-related redox reactions.

In a first aspect, the present invention provides a low-dimensional tellurium iodide perovskite structure, comprising an inorganic-organic hybrid material. The low-dimensional tellurium iodide perovskite structure enables multi-electron redox reactions involving chalcogen and halogen elements, achieving an eleven-electron transfer process including redox pairs of Cl⁰/Cl⁻, I⁺/I⁰/I⁻, and Te⁶⁺/Te⁴⁺/Te⁰/Te²⁻, and the low-dimensional tellurium iodide perovskite structure confines the chalcogen and halogen elements, thereby reducing ion crossover.

In one embodiment, the inorganic-organic hybrid material comprises an organic-inorganic hybrid chalcogen halide perovskite.

Preferably, the organic-inorganic hybrid chalcogen halide perovskite comprises a benzyltriethylammonium tellurium iodide ((BzTEA)₂TeI₆) framework. The perovskite framework is characterized by Van der Waals forces, including halogen and hydrogen bonds, which contribute to the structural confinement of active elements and the suppression of the shuttle effect.

In one embodiment, the tellurium serves as a multi-valent B-site cation, achieving a high coulombic efficiency approaching 98% while coupled with the designed battery configuration.

In one embodiment, the inorganic-organic hybrid material is synthesized by a saturated recrystallization process, utilizing tellurium oxide and benzyltriethylammonium chloride in an aqueous medium.

In a second aspect, the present invention provides an aqueous zinc battery, which includes a cathode having a cathode material, a zinc anode, an aqueous electrolyte, and a separator. The aqueous electrolyte enables high chloride ion mobility and supports reversible redox reactions of chalcogen and halogen elements in the cathode to provide enhanced cycling stability and energy density. The cathode and zinc anode are positioned on opposite sides of the separator, the aqueous electrolyte fills the internal space around the cathode, the anode, and the separator. The aqueous zinc battery exhibits a capacity retention rate of at least 77% after 500 cycles at a current density of 1 A g⁻¹.

In one embodiment, the cathode material includes an inorganic-organic hybrid material including an organic-inorganic hybrid chalcogen halide perovskite, the organic-inorganic hybrid chalcogen halide perovskite enables multi-electron redox reactions involving chalcogen and halogen elements, achieving an eleven-electron transfer process including redox pairs of Cl⁰/Cl⁻, I⁺/I⁰/I⁻, and Te⁶⁺/Te⁴⁺/Te⁰/Te²⁻.

In one embodiment, the organic-inorganic hybrid chalcogen halide perovskite confines the chalcogen and halogen elements, thereby reducing ion crossover.

In one embodiment, the organic-inorganic hybrid chalcogen halide perovskite includes a benzyltriethylammonium tellurium iodide ((BzTEA)₂TeI₆) framework.

In one embodiment, the tellurium serves as a multi-valent B-site cation, contributing to a special eight electron transfer process from Te²⁻ to Te⁰, Te⁴⁺, and Te⁶⁺ within the framework by stabilizing high-valent tellurium ions through interaction with chloride ions in the aqueous electrolyte.

In another embodiment, the cathode further includes a current collector, one or more electrically conductive particles, or a binder.

The current collector contains one selected from the group consisting of carbon cloth, carbon paper, graphite paper, Ti foil/mesh, and stainless steel that are compatible with the cathode material.

In one embodiment, the zinc anode includes zinc plate, zinc powder or zinc foil.

In one embodiment, the aqueous electrolyte includes zinc slats and choline chloride as a solute.

In particular, the electrolyte includes zinc chloride and choline chloride, delivering an average discharge voltage of approximately 1.3 V through multiple redox pairs.

Preferably, the aqueous electrolyte is Ch_{0.4}Zn_{0.6}Cl_{1.6}·nH₂O, where 1.45≤n≤1.55.

In one embodiment, the separator includes glass fibers, polymer films, and nonwoven fibers.

In another aspect. the aqueous zinc battery is further configured as a pouch cell, providing a capacity of at least 113 mAh and retaining over 66% capacity after 100 cycles.

The developed perovskite structure effectively confines active elements, mitigating the shuttle effect and facilitating fast transfer of Cl⁻ on its surface. This allows for the utilization of inert high-valent tellurium cations, eventually realizing an impressive and highly reversible eleven-electron transfer mode on account of the two-electron I⁺/I⁰/I⁻ and eight-electron Te⁶⁺/Te⁴⁺/Te⁰/Te²⁻ redox reactions, and one-electron Cl⁰/Cl⁻ transfer gained from the chloride electrolyte. All of which favor a high discharge capacity at least 450 mAh g⁻¹_{Te/I} and a remarkable energy density of 550-600 Wh kg⁻¹_{Te/I} at 0.5 A g⁻¹ represented by five prominent voltage plateaus at 1.81 V, 1.64 V, 1.53 V, 1.26 V, and 0.51 V.

By addressing these challenges, researchers can unlock the full potential of perovskite materials in energy applications, paving the way for innovative solutions in the realm of renewable energy.

Relative to current technology, the key benefits of the present inventions are:
(1) The present invention proposes organic-inorganic hybrid chalcogen halide perovskites and their derivatives as an effective conversion-type cathode;
(2) The proposed single-phase electrolyte, Ch_{0.4}Zn_{0.6}Cl_{1.6}·nH₂O (1.45≤n≤1.55), is highly supportive for the conversion reactions on the cathode electrode;
(3) An eleven-transfer process involving Cl⁰/Cl⁻¹ (1.81 V), I⁺/I⁰/I⁻ (1.64 and 1.26 V), Te⁶⁺/Te⁴⁺ (1.53 V), Te⁴⁺/Te⁰ (1.26 V), and Te⁰/Te²⁻ (0.51 V) is successfully achieved; and
(4) The Zn∥(BzTEA)₂TeI₆ battery offers a high capacity of at least 450 mAh g⁻¹_{Te/I} at 0.5 A g⁻¹ and a high energy density of 550-600 Wh kg⁻¹_{Te/I}.

### BRIEF DESCRIPTION OF THE DRAWINGS

Embodiments of the invention are described in more details hereinafter with reference to the drawings, in which:

FIG. 1A shows redox potential of chalcogens and halogens. FIG. 1B shows a simplified diagram of 3D perovskites (ABX₃) and their low-dimensional derivatives;

FIG. 2 shows the structural arrangement of low-dimensional (BzTEA)₂TeI₆ perovskite, where tellurium and iodine elements sit as the B- and X-site components, respectively;

FIG. 3 shows a SEM image of (BzTEA)₂TeI₆ perovskites;

FIG. 4A shows a photography (inset) and XRD patterns of (BzTEA)₂TeI₆. FIG. 4B shows XRD patterns of (BzTEA)₂TeI₆ and other perovskite materials;

FIG. 5 shows absorption spectra of (BzTEA)₂TeI₆ perovskites represented by Kubelka-Munk function, F(R);

FIG. 6A shows SEM images of (BzTEA)₂TeI₆ perovskite microcrystals. FIG. 6B shows EDS spectra of (BzTEA)₂TeI₆ perovskite microcrystals;

FIG. 7A shows FTIR spectra of the (BzTEA)Cl, and (BzTEA)₂TeI₆ perovskite microcrystals. FIG. 7B shows the enlarged view of the precursor, (BzTEA)Cl, and (BzTEA)₂TeI₆ perovskite microcrystals;

FIG. 8A shows TGA of (BzTEA)Cl and (BzTEA)₂TeI₆ perovskites. FIG. 8B shows the corresponding DTA curves of (BzTEA)Cl and (BzTEA)₂TeI₆ perovskites;

FIG. 9 shows Raman spectra of TeO₂ and (BzTEA)₂TeI₆ perovskites;

FIG. 10A shows the CV curves of the perovskite cathode in 2 M ZnSO₄ (first two cycles). FIG. 10B shows CV curve of the Zn∥(BzTEA)₂TeI₆ battery coupled with 15 M ZnCl₂ electrolyte; FIG. 10C shows CV curves of Zn∥(BzTEA)₂TeI₆ batteries coupled with Zn(OTF)₂ and Zn(OAc)₂ electrolytes, respectively;

FIG. 11A shows the CV curves of the perovskite cathode in 30 M ZnCl₂. FIG. 11B shows enlarged CV curve of the Zn∥“Te+I₂” battery depicted in FIG. 11A;

FIG. 12A shows the CV curves of the perovskite cathode in Ch_{0.4}Zn_{0.6}Cl_{1.6}·1.5H₂O. FIG. 12B shows CV curves of Zn-ion batteries coupled with “Te+I₂” and “TeO₂+ZnI₂” cathodes, respectively, and performed in the Ch_{0.4}Zn_{0.6}Cl_{1.6}·1.5H₂O electrolyte;

FIG. 13 shows CV curves of batteries coupled with “TeO₂+ZnI₂” cathode in Ch_{0.4}Zn_{0.6}Cl_{1.6}·1.5H₂O electrolyte;

FIG. 14 shows formation energy of high-valent tellurium ions under different conditions;

FIG. 15A shows CV curves of batteries coupled with “(BzTEA)₂TeI₆” cathode in Ch_{0.4}Zn_{0.6}Cl_{1.6}·1.5H₂O electrolyte. FIG. 15B shows CV curve of the Zn∥(BzTEA)₂TeI₆ battery which represents the capacitive contribution (marked in grey color) at 1 mV s⁻¹;

FIG. 16A shows diffusion-/surface-controlled contribution at different scan rates. FIG. 16B shows diffusion-/surface-controlled contribution of the Zn∥“TeO₂+ZnI₂” battery at different scan rates;

FIG. 17A shows the fitting plots between log (i) and log (v) of the cathodic peaks. FIG. 17B shows fitting plots between log (i) and log (v) of the cathodic peaks derived from the Zn∥“TeO₂+ZnI₂” battery;

FIG. 18A shows a summary diagram of the derived b value. FIG. 18B shows CV curves of the diffusion-/surface-controlled contribution of Zn∥30 M ZnCl₂∥(BzTEA)₂TeI₆ battery. FIG. 18C shows evolution of the diffusion-/surface-controlled contribution of Zn∥30 M ZnCl₂∥(BzTEA)₂TeI₆ battery. FIG. 18D shows the fitting plots between log (i) and log (v) of the cathodic peaks;

FIG. 19 shows discharge curve at a current density of 0.5 A g⁻¹ demonstrates the redox reactions of tellurium and halogen elements.

FIG. 20 shows differential capacity (dQ/dV) plot of the Zn∥(BzTEA)₂TeI₆ battery;

FIG. 21A shows charge and discharge curves and corresponding in situ Raman mapping of Zn∥(BzTEA)₂TeI₆ battery. FIG. 21B shows Raman spectra recorded at 0.3 V and 1.7 V semi-qualitatively demonstrating the presence of I₅⁻ and Te⁶⁺ under high voltage;

FIG. 22 shows Raman spectrum of the separator of the cycled Zn∥(BzTEA)₂TeI₆ battery;

FIG. 23 shows XRD patterns of the perovskite cathode electrode in different discharging states;

FIG. 24A shows XPS spectra of Te3d core levels. FIG. 24B shows XPS spectra of Cl2p core levels. FIG. 24C shows XPS spectra of I3d_{3/2} core levels;

FIG. 25A shows visualization of ZnCl₂·1.4H₂O (left) and Ch_{0.4}Zn_{0.6}Cl_{1.6}·1.5H₂O (right) electrolytes. FIG. 25B shows geometric illustration of the coordination of Zn ions in different electrolytes;

FIG. 26A shows MSD spectra derived from MD simulations. FIG. 26B shows RDF spectra derived from MD simulations;

FIG. 27A shows XRD pattern of the Ch_{0.4}Zn_{0.6}Cl_{1.6}·1.5H₂O electrolyte. FIG. 27B shows dynamic light scattering spectrum of the Ch_{0.4}Zn_{0.6}Cl_{1.6}·1.5H₂O electrolyte;

FIG. 28 shows migration energy of chloride ions on TeO₂ and perovskite surface;

FIG. 29 shows formation energy of associated redox pairs in vacuum and on perovskite surface;

FIG. 30 shows surface adsorption energy of (BzTEA)₂TeI₆ toward intermediate tellurium and halogen elements. The insert denotes the coordination between perovskite and TeCl₅⁺ ions;

FIG. 31A shows charge density isosurface at (10-1) facet of (BzTEA)₂TeI₆ showing the absorbed TeCl₅⁺ and TeCl₃⁺ by virtue of the Te dangling bond and Te—Cl . . . I halogen bonds.

FIG. 31B shows an illustration of the coordination between TeCl₃⁺ and the perovskite surface, arising from the Te—I . . . Cl—Te halogen bond. FIG. 31C shows visualization of calculated adsorption energy of active species (Cl₂, Cl⁻, I⁻, Te, TeCl₃⁺, etc.) on the surface of low-dimensional (BzTEA)₂TeI₆ perovskite;

FIG. 32 shows rate performance of the Zn∥(BzTEA)₂TeI₆ battery;

FIG. 33 shows UV absorption spectra of the separator which were taken from cycled batteries based on “TeO₂+ZnI₂” and (BzTEA)₂TeI₆ cathodes;

FIG. 34 shows the corresponding GCD curves of Zn∥(BzTEA)₂TeI₆ battery;

FIG. 35 shows rate performance and the corresponding GCD curves of a Zn∥30 M ZnCl₂∥(BzTEA)₂TeI₆ and Zn∥Ch_{0.4}Zn_{0.6}Cl_{1.6}·1.5H₂O∥“TeO₂+ZnI₂”;

FIG. 36 shows comparison with typical cathode of zinc ion batteries;

FIG. 37A shows long-term cycling property of zinc battery at 1 A g⁻¹. FIG. 37B shows selected GCD curves of Zn∥(BzTEA)₂TeI₆ battery. FIG. 37C shows long-term cycling property of the Zn∥(BzTEA)₂TeI₆ battery at 3 A g⁻¹;

FIG. 38 shows the figure of merit for the Zn∥(BzTEA)₂TeI₆ battery in terms of cycle number and coulombic efficiency;

FIG. 39A shows the self-discharge profile of Zn∥(BzTEA)₂TeI₆ battery. FIG. 39B shows the self-discharge profile of the Zn∥“TeO₂+I₂” battery.

FIG. 40 shows voltage profile of the Zn∥(BzTEA)₂TeI₆ battery before and after integration with a DC-DC converter;

FIG. 41A shows a comparison of relative aqueous zinc ion batteries regarding average voltage and energy density. FIG. 41B shows cycling performance of the pouch cell with a high loading mass of 12 mg cm⁻²; FIG. 41C shows self-discharge profile of the pouch cell after varying storage periods.

### DETAILED DESCRIPTION

Low-dimensional metal-halide perovskites are garnering significant attention for energy storage applications. However, their potential as conversion-type cathode materials is still somewhat restricted. One critical challenge is that the B-site metal cations in perovskite structures stay electrochemical inert, diminishing their capacity and energy density. This inertness hinders the full utilization of the material's properties, preventing the advancement of perovskite-based technologies in energy storage.

Halide perovskite materials, along with their derivatives, have shown potential as halogen reservoirs and mitigate the shuttle effect whereas the previous attempts have been hindered by the electrochemical inertness of the B-site cations which undermines the overall discharge capacity. These challenges underscore the importance of conversion-type chemistry, which has the potential to unlock the full potential of perovskite cathode electrodes for high-energy aqueous batteries.

Accordingly, the present invention relates to a low-dimensional tellurium iodide perovskite structure composed of a hybrid organic-inorganic framework that enables a highly efficient multi-electron redox process. This unique structure achieves an unprecedented eleven-electron transfer involving redox pairs of Cl⁰/Cl⁻, I⁺/I⁰/I⁻, and Te⁶⁺/Te⁴⁺/Te⁰/Te²⁻, enabling significant advancements in electrochemical energy storage applications. This configuration presents innovative solutions to the existing limitations in redox efficiency, stability, and cycling performance in high-energy-density batteries, setting it apart from traditional perovskite-based materials.

In particular, the perovskite structure contains benzyltriethylammonium tellurium iodide (BzTEA)₂TeI₆, as a cathode material. It helps actualize both B-site chalcogen and X-site halogen redox reactions by confining active chalcogen and halogen elements. It also facilitates the rapid transfer of chloride ions, thereby stabilizing high-valent tellurium cations in the form of tellurium chloride ions.

In one embodiment, the tellurium functions as a multi-valent B-site cation. This positioning of tellurium within the perovskite structure not only stabilizes high-valent tellurium ions but also facilitates a multi-electron redox process. This is a marked improvement over existing perovskite structures, which have traditionally faced challenges with the electrochemical inertness of B-site cations, limiting redox versatility and capacity.

In one embodiment, the confinement of active chalcogen and halogen elements within the perovskite structure minimizes ion crossover. This spatial confinement is achieved through a combination of Van der Waals forces, including halogen and hydrogen bonds, which interact with the A-site organic cations to effectively suppress the shuttle effect.

The synthesis of the low-dimensional tellurium iodide perovskite structure follows a simple, yet effective, saturated recrystallization process. This method involves reacting tellurium oxide with benzyltriethylammonium chloride in an aqueous medium, followed by a cooling step and subsequent isopropanol wash to yield the (BzTEA)₂TeI₆ microcrystals. This synthetic approach is not only cost-effective but also ensures a uniform and stable crystal structure that is well-suited for scalable production. The resultant microcrystals are optimized for high redox efficiency, capacity retention, and stable cycling performance.

The perovskite structure is found to effectively confine active elements, mitigating the shuttle effect and facilitating fast transfer of Cl⁻ on its surface. This allows for the utilization of inert high-valent tellurium cations, eventually realizing a special eleven-electron transfer mode (Te⁶⁺/Te⁴⁺/Te²⁻, I⁺/I⁰/I⁻, and Cl⁰/Cl⁻) when a suitable electrolyte is adopted.

In another aspect, the eleven-electron transfer is successfully realized in the Zn∥(BzTEA)₂TeI₆ batteries, offering a model system to fully exploit the cathode materials for high-energy and durable aqueous zinc batteries for large-scale energy storage.

The (BzTEA)₂TeI₆ perovskite has been demonstrated as an effective approach for realizing both B-site chalcogen and X-site halogen redox reactions, and is explored here as a promising conversion-type cathode material. The (BzTEA)₂TeI₆ cathode effectively confines active chalcogen and halogen elements and allows fast transfer of chloride ions, stabilizing high-valent tellurium cations in the form of tellurium chloride ions. After coupling with the adaptive Ch_{0.4}Zn_{0.6}Cl_{1.6}·1.5H₂O electrolyte, an eleven-electron transfer is successfully realized in the Zn∥(BzTEA)₂TeI₆ batteries as the emerging redox pairs including Cl⁰/Cl⁻¹ (1.81 V), I⁺/I⁰/I⁻ (1.64 and 1.26 V), Te⁶⁺/Te⁴⁺ (1.53 V), Te⁴⁺/Te⁰ (1.26 V), and Te⁰/Te²⁻ (0.51 V), all of which benefit a high energy density of over 577 Wh kg⁻¹_{Te/I}.

In one embodiment, the cathode may further include a current collector, one or more electrically conductive particles, or a binder. The current collector may be one selected from the group consisting of carbon cloth, carbon paper, graphite paper, Ti foil/mesh, and stainless steel that are compatible with the cathode material.

In one embodiment, the zinc anode includes zinc plate, zinc powder or zinc foil.

In one embodiment, the aqueous electrolyte comprises zinc slats and choline chloride as a solute. In particular, the electrolyte contains zinc chloride and choline chloride, delivering an average discharge voltage of approximately 1.3 V through multiple redox pairs.

In one embodiment, the aqueous electrolyte comprises Ch_{0.4}Zn_{0.6}Cl_{1.6}·nH₂O, where 1.45≤n≤1.55.

In one embodiment, the separator includes glass fibers, polymer films, and nonwoven fibers.

The Zn∥(BzTEA)₂TeI₆ battery exhibits a high capacity of up to 473 mAh g⁻¹_{Te/I} and an impressive energy density of 577 Wh kg-⁻¹_{Te/I} at 0.5 A g⁻¹, with favorable capacity retention up to 77% after 500 cycles at 1 A g⁻¹.

When configured as a pouch cell, the battery delivers a capacity of at least 113 mAh and retains over 66% of its initial capacity after 100 cycles, demonstrating excellent durability and capacity retention. These performance metrics are highly favorable for commercial energy storage solutions, especially in applications demanding high reliability over extended cycles.

Moreover, the present invention also pertains to methods for synthesizing an organic-inorganic hybrid tellurium iodide perovskite, (BzTEA)₂TeI₆, along with a compatible electrolyte, Ch_{0.4}Zn_{0.6}Cl_{1.6}.1.5H₂O (Ch denotes choline cations), aimed at achieving a high-energy zinc battery capable of highly reversible eleven-electron transfer. The formula simply synthesizes (BzTEA)₂TeI₆ at room-temperature by a saturated recrystallization method and rinsed by isopropanol for the use as cathode materials, working in conjunction with an appropriate mixture of saturated/concentrated choline chloride and zinc chloride.

The robust Van Der Waals forces such as Te—I . . . Cl—Te and Te—I . . . I halogen bonds on the perovskite surface promote the localization of active elements and avert the undesired shuttling of oxidative polyiodide and tellurium polychloride ions, together with high Cl⁻ mobility that helps compensate high-valent tellurium cations, as supported by the density functional theory (DFT) calculations and molecule dynamics (MD) simulations.

The present invention distinguishes itself from existing technologies through its combination of high multi-electron transfer capability, spatial confinement of active elements, and a robust synthetic approach. By addressing critical challenges such as ion crossover, redox efficiency, and cycling stability, this low-dimensional tellurium iodide perovskite structure enables high-performance applications that were previously unachievable with conventional perovskite materials. This invention thus represents a significant advancement in the field of electrochemical energy storage, offering both superior energy density and long-term stability.

### EXAMPLE

### Example 1—Materials and Methods

### Chemicals and Reagents

Tellurium oxide (≥99%), benzyltriethylammonium chloride (BzTEACl or TEBAC, 98%), hydrogen iodide (HI, 48%), isopropanol (99%), zinc chloride (98%), choline chloride (ChCl, 98%), zinc sulfate (ZnSO₄, AR), zinc acetate (Zn(OAc)₂, 99%), zinc trifluoromethanesulfonate (Zn(OTF)₂, 98%) and 1-methyl-2-pyrrolidinone (NMP, 98%) are purchased from Aladdin. Polyvinylidene difluoride (PVDF) is purchased from SOLVAY (Solef 1008). The conductive agent, Ketjenblack EC-300J, is purchased from Nouryon. All chemicals are used as received without further treatment.

### Electrochemical Characterization

Absorption spectra are collected using a Shimadzu UV 3600 UV/visible/IR spectrophotometer, while Fourier-transform infrared (FTIR) measurements are conducted with a Perkin Elmer FT-IR spectrophotometer. Raman measurements are performed on a WITec Alpha300 R confocal Raman imaging system with a 532 nm laser. Powder X-ray diffraction (XRD) patterns are obtained using a Rigaku Smartlab X-ray diffractometer with Cu Kα radiation (λ=1.5406 Å). X-ray photoelectron spectroscopy (XPS) is carried out on a PHI model 5802, with the carbon spectrum serving as a calibration reference. The FEI Quanta 250 scanning electron microscope (SEM) and energy dispersive spectroscopy (EDS) are utilized to examine the morphology and elemental composition of the samples. Cyclic voltammograms (CVs) and related electrochemical data are collected on a CHI 660E electrochemical workstation. The long-term stability and rate performance of the batteries are evaluated using the LAND battery testing system at room temperature.

### Calculation and Theoretical Simulations

The b value is derived from the equation i=av^{b} where i is the response current, v is the sweep rate. The b value of 0.5 signifies a purely faradaic (diffusion-controlled) process while a b value of 1 indicates a purely capacitive (surface-controlled) process. The quantitative contribution of the charge storage process is evaluated by the equation i=k₁v+k₂v^{0.5} where k₁v is the surface-controlled process and k₂v^{0.5} is the diffusion-controlled part. The DFT is employed for first-principles calculations using the Dmol3 mode within a numerical atom-centered basis function framework. The Perdew-Burke-Ernzerhof (PBE) method is used for electronic exchange-correlation interactions, while the Generalized Gradient Approximation (GGA) method with PBE formulation is applied for structural optimization. DFT semi-core pseudopotentials are chosen for the core treatment of relativistic effects, replacing core electrons with a single effective potential.

The adsorption energy, Eads, is calculated using the following formula:

$${E}_{ads} = {E}_{ensemble} - {E}_{absorbent} - {E}_{adsorbate} ,$$

where the subscript represents the energy of the absorbent, adsorbate, or the entire system post adsorption.

### Example 2

Preparation of (BzTEA)₂TeI₆ Microcrystal Cathode and Battery Assembly

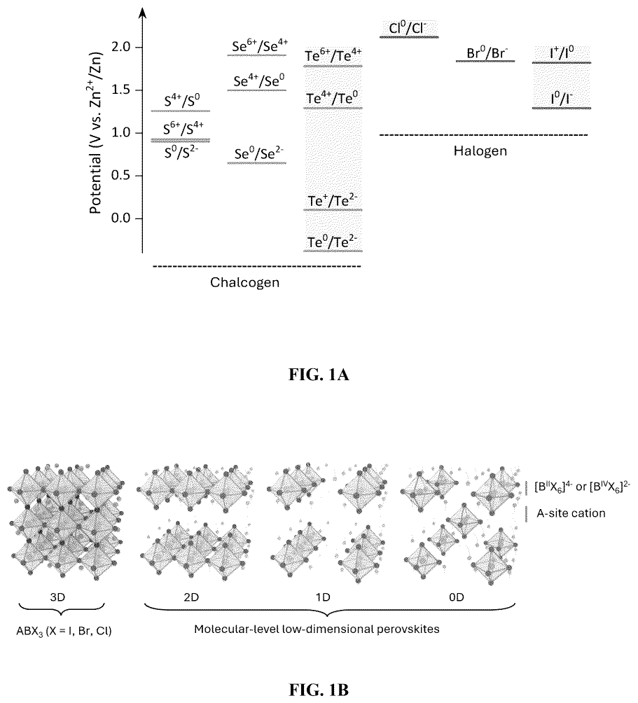

Chalcogens, such as sulfur, selenium, and tellurium, display a broad spectrum of valence states (−2, 0, +2, +4, +6) and exhibit significant redox potentials (FIG. 1A). This characteristic theoretically renders them suitable for energy storage, while the stability of high-valent chalcogen cations remains a crucial consideration. Halogens, on the other hand, are proven effective in giving high redox potentials in aqueous zinc ion batteries. A proper integration of chalcogen and halogen chemistry should promote problem-solving and actualize high-energy zinc ion batteries. Implementing halogen redox in halide perovskites highlights the potential for structural design and encourages the exploration of chalcogen halide perovskites as cathode materials. In contrast, the molecular-level LD perovskite materials crystalize in a way where the [BX₆]⁴⁻ octahedron unit is separated by A-site cations in specific directions and upholds a high structural tunability (FIG. 1B). Actually, the typical ABX₃ perovskites consist of corner-sharing [BX₆]⁴⁻ octahedra and offset of A-site atoms in octahedrons cavities throughout the whole 3D matrix⁴.

This example seeks to replace conventional electrochemically inert B-site cations with tetravalent chalcogenide cations, while maintaining the octahedral BX₆ motif, to facilitate the formation of A₂B^{IV}X₆ vacancy-ordered perovskites. This change is expected to maximize the utilization of perovskite materials by enabling multivalent reactions (B²⁻/B⁰/B⁴⁺/B⁶⁺) of both chalcogen and halogen elements, as depicted in FIG. 1A.

The perovskite microcrystals are obtained by a saturated recrystallization method. Specifically, 0.1 mmol of TeO₂ and 0.2 mmol of BzTEACl are added into 1 ml HI solution. The mixture is heated to 110° C. and held for over 1 hour with vigorous stirring, subsequently cooling to room temperature. The obtained black residue is washed with isopropanol and dried under a vacuum. The (BzTEA)₂TeI₆ perovskite microcrystals are mixed and ground with Ketjenblack and PVDF blinder in NMP with a mass ratio of 7:2:1 for 1 hour. The obtained liquid slurry is evenly covered on the carbon cloth substrate, followed by a vacuum bakeout process at around 80° C. overnight. The special lattice arrangement ensures the confinement of chalcogen and halogen elements in the same perovskite structure, which creates the platform for chalcogen- and halogen-related redox reactions for high-energy batteries.

The mass loading of the perovskite cathode is estimated to be 1-1.2 mg cm⁻². 39 mmol ZnCl₂ is dissolved in 1 ml H₂O at 100° C. and slowly cooling to 30° C., and the clear supernatant is used as the ZnCl₂·1.4H₂O electrolyte. 0.4 mol ChCl and 0.6 mol ZnCl₂ are dissolved in 1.5 mol H₂O to form the Ch_{0.4}Zn_{0.6}Cl_{1.6}·1.5H₂O electrolyte. Specifically, 1 g of Ch_{0.4}Zn_{0.6}Cl_{1.6}·1.5H₂O contains 0.16 g H₂O, 0.51 g ChCl, and 0.33 g ZnCl₂. The cathode, zinc metal anode, and a glass fiber sat in between are packed in a Swagelok cell for further evaluation.

As summarized in Table 1, the cogitation theoretically upholds high redox potential and multiple electron transfer associated with B-site chalcogen and X-site halogens of the perovskite cathode materials, attempting to overcome the deficiency of conventional chalcogen cathodes and enable the electrochemically inert high-valent chalcogen redox⁵⁻⁶.

TABLE 1
Standard electrode potentials of halogen and chalcogen elements

| Elements | Redox pair | Reaction | E⁰/V | V vs. Zn²⁺/Zn |
|---|---|---|---|---|
| Chalcogen | S⁶⁺/S⁴⁺ | SO₄²⁻ + 4H⁺ + 2e [symbol] SO₂(aq) + 2H₂O | 0.17 | 0.93 |
| | S⁴⁺/S⁰ | SO₂(aq) + 4H⁺ + 4e [symbol] S(s) + 2H₂O | 0.5 | 1.26 |
| | S⁰/S²⁻ | S (s) + 2H⁺ + 2e [symbol] H₂S (g) | 0.14 | 0.9 |
| | Se⁶⁺/Se⁴⁺ | HSeO₄⁻ + 3H⁺ + 2e [symbol] H₂SeO₃(aq) + H₂O | 1.15 | 1.91 |
| | Se⁴⁺/Se⁰ | H₂SeO₃ + 4H⁺ + 4e [symbol] Se + 3H₂O | 0.74 | 1.5 |
| | Se⁰/Se²⁻ | Se (s) + 2H⁺ + 2e [symbol] H₂Se (g) | −0.11 | 0.65 |
| | Te⁶⁺/Te⁴⁺ | H₆TeO₆(aq) + 2H⁺ + 2e [symbol] TeO₂(s) + 4H₂O | 1.02 | 1.78 |
| | Te⁴⁺/Te⁰ | TeO₂(s) + 4H⁺ + 4e [symbol] Te(s) + 2H₂O(l) | 0.53 | 1.29 |
| | Te⁻/Te²⁻ | Te₂²⁻ + 4H⁺ + 2e [symbol] 2H₂Te | −0.64 | 0.10 |
| | Te⁰/Te²⁻ | Te (s) + 2e [symbol] Te²⁻ | −1.14 | −0.38 |
| Halogen | Cl⁰/Cl⁻ | Cl₂(g) + 2e [symbol] 2Cl⁻ | 1.36 | 2.12 |
| | Br⁰/Br⁻ | Br₂(aq) + 2e [symbol] 2Br⁻ | 1.08 | 1.84 |
| | I⁺/I⁰ | ICl₂⁻ + e [symbol] 2Cl⁻ + I(s) | 1.06 | 1.82 |
| | I⁰/I⁻ | I₂(s) + 2e [symbol] 2I⁻ | 0.53 | 1.29 |

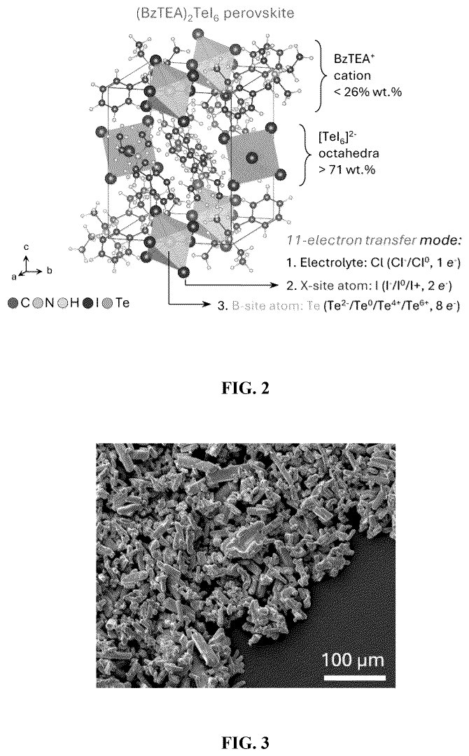

The high charge density surrounding each tetravalent Te⁴⁺ cation causes the formation of the tellurium-iodide octahedron unit, which is embedded in the A-site organic ligands (BzTEA) matrix and supplies high elemental iodine and tellurium content of over 71 wt. %. The (BzTEA)₂TeI₆ perovskite possessing a high proportion of active elements is thus proposed as conversion-type cathodes for aqueous zinc ion batteries with a special eleven-electron transfer process, as shown in FIG. 2.

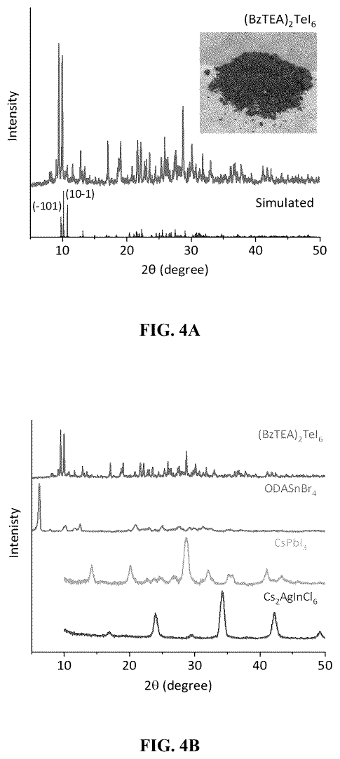

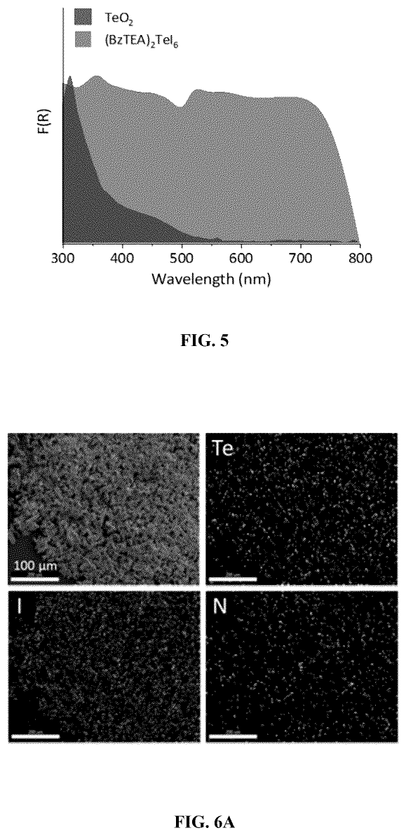

Regardless of the molecular-level lattice structure (BzTEA)₂TeI₆ microcrystals prepared by a modified saturation recrystallization method, formed bulk rod-like structures with an average length of under 50 μm, as shown in the scanning electron microscope (SEM) image in FIG. 3. The perovskite microcrystals exhibit XRD diffraction patterns that match the theoretical simulation shown in FIGS. 4A-4B and appear black due to their narrow optical bandgap, which is consistent with the ultraviolet absorption spectra presented in FIG. 5.

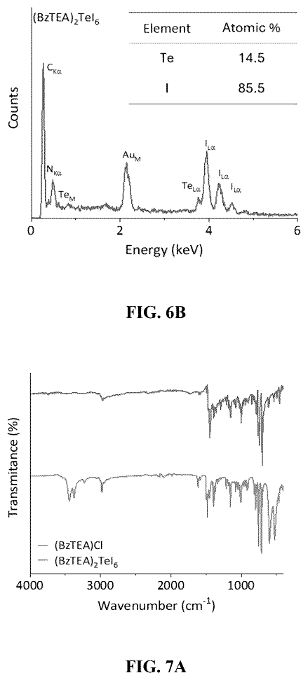

Referring to FIGS. 6A-6B, the SEM-mapping further reveals the even elemental distribution of (BzTEA)₂TeI₆ microcrystals associated with 14.5 at. % of Te and 85.5 at. % of I according to the energy-dispersive X-ray spectroscopy (EDS) test.

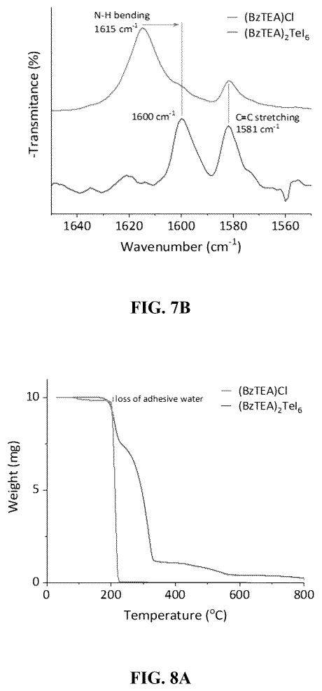

Fourier Transform Infrared (FTIR) spectra in FIGS. 7A-7B indicates the protonation of A-site N—H bond in (BzTEA)₂TeI₆.

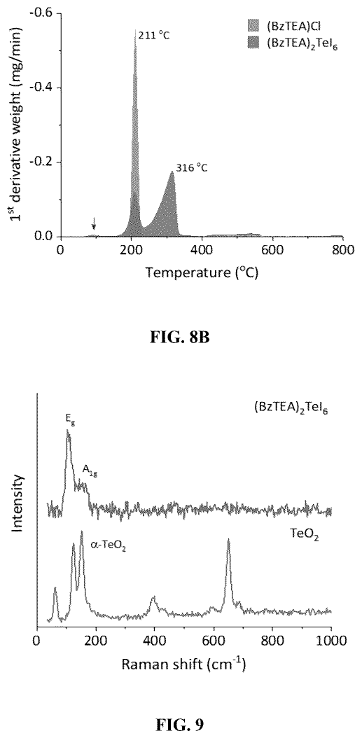

Thermogravimetric analysis (TGA) and derivative thermogravimetry (DTG) curves in FIGS. 8A-8B confirm the structural stability and hydrophobic feature of the tellurium iodide perovskite according to the negligible weight loss below 211° C.

Raman spectra in FIG. 9 reveals symmetric A_{1g} and asymmetric E_{g} stretching of Te—I bond at approximately 153 cm⁻¹ and 107 cm⁻¹ in (BzTEA)₂TeI₆, resembling the Te—O bond observed in TeO₂.

### Example 3

### Tellurium and Halogen Redox

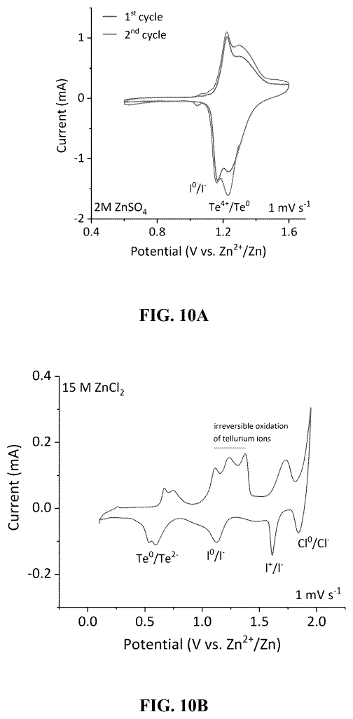

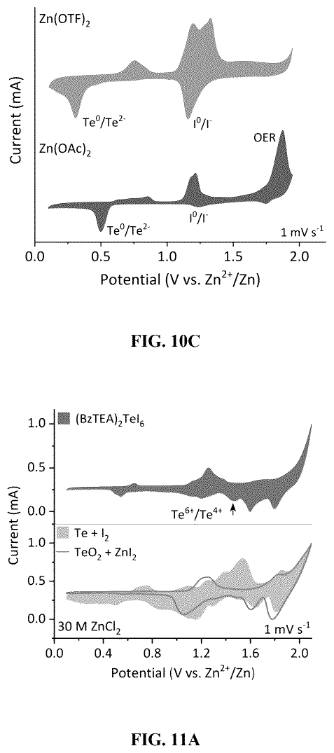

The halide perovskite cathode is initially tested in Zn∥2M ZnSO₄∥(BzTEA)₂TeI₆ Swagelok cells, showing two redox peaks corresponding to I₀/I⁻ and Te⁴⁺/Te⁰. The latter undergoes a rapid current decay, as observed in the cyclic voltammetry (CV) curves in FIG. 10A. In contrast, electrolytes of 2 M Zn(OTF)₂, 2 M Zn(OAc)₂, and 15 M ZnCl₂ electrolytes all fail to activate the redox reaction of high-valent tellurium cations (FIGS. 10B-10C). 30 M ZnCl₂, containing reduced amount of free water, is then used as the electrolyte with an attempt to stabilize the tetravalent tellurium cations. Surprisingly, it enables the perovskite cathode with an additional Te⁶⁺/Te⁴⁺ redox at around 1.5 V.

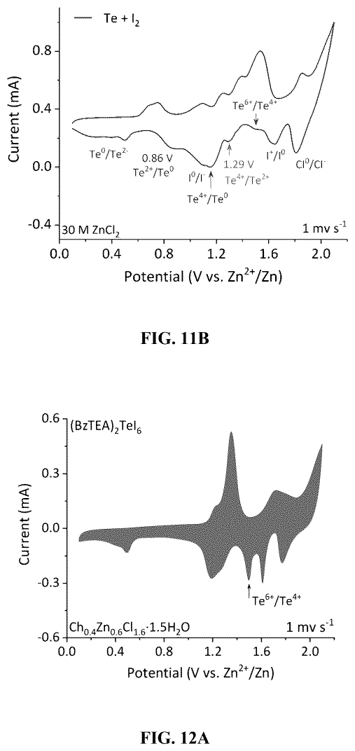

Surprisingly, it enables the perovskite cathode with an additional Te⁶⁺/Te⁴⁺ redox at around 1.5 V. It should be noted that the Te⁶⁺/Te⁴⁺ redox is utterly absent in the “TeO₂+ZnI₂” and “Te+I₂” cathodes (FIGS. 11A-11B), which reveals the special structure of (BzTEA)₂TeI₆ for activation of the new redox. The observation also suggests that the activity of water and chloride anions may play an essential role in stabilizing high-valent tellurium cations.

Based on this, choline chloride (ChCl) is introduced into the concentrated ZnCl₂ electrolyte to create the Ch_{0.4}Zn_{0.6}Cl_{1.6}·1.5H₂O electrolyte. This electrolyte exhibits limited water activity and sufficient chloride ion mobility to coordinate with high-valent tellurium cations during cycling.

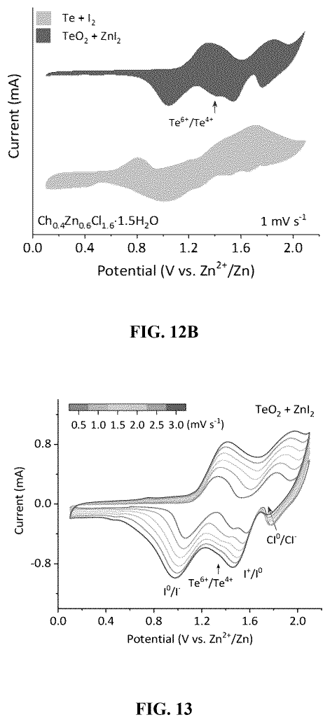

As shown in FIG. 12A, the Zn∥Ch_{0.4}Zn_{0.6}Cl_{1.6}·1.5H₂O∥(BzTEA)₂TeI₆ configuration exhibits prominent discharge peaks, including the Te⁶⁺/Te⁴⁺ and Te⁴⁺/Te⁰ redox pairs at 1 mV. In stark contrast, both “TeO₂” and “Te+I₂” cathodes fail to activate the Te⁶⁺/Te⁴⁺ redox reaction, even when coupled with the same modified electrolyte, further emphasizing the unique chemical design of (BzTEA)₂TeI₆ (FIG. 12B).

To investigate the critical role of the (BzTEA)₂TeI₆ perovskite structure, detailed electrochemical studies of these batteries are subsequently conducted.

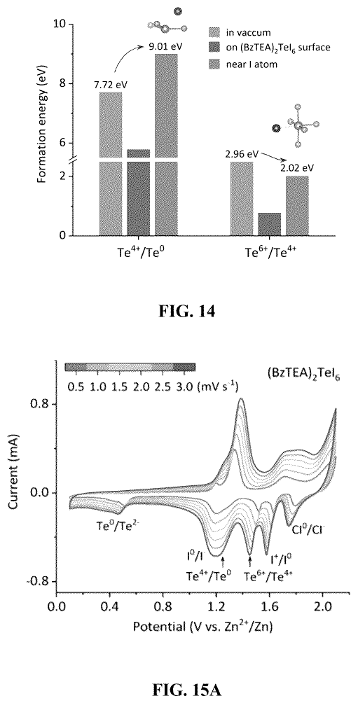

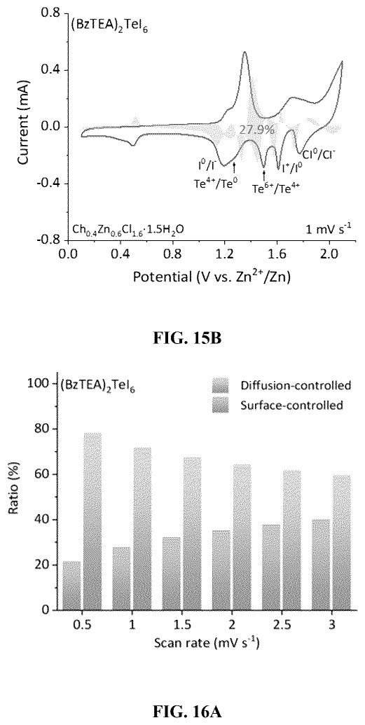

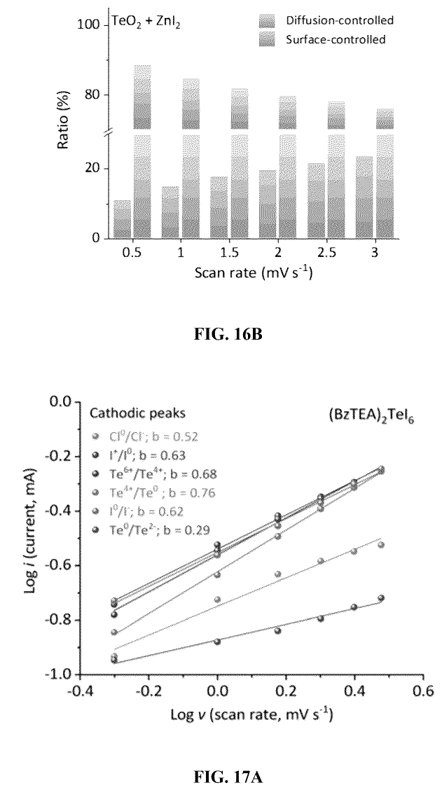

As shown in FIG. 13, the “TeO₂+ZnI₂” cathode presents two types of redox, including I⁰/I⁺/I⁻ and Cl⁰/Cl⁻, which experience an unusual attenuation as the scan rate increased, together with a mild Te⁶⁺/Te⁴⁺ redox reaction probably due to the catalytic role of iodine atom (FIG. 14). In contrast, the (BzTEA)₂TeI₆ cathode features four distinct discharge peaks corresponding to the Cl₀/Cl⁻, I⁺/I₀, Te⁶⁺/Te⁴⁺, and Te⁰/Te²⁻ redox couples, along with a broad peak resulting from the overlap of the Te⁴⁺/Te⁰ and I₀/I⁻ couples (FIGS. 15A-15B). Further, as illustrated in FIG. 16A, the surface-controlled process of the battery based on perovskite cathodes gradually grew from 21.5% at 0.5 mV s⁻¹ to 40.2% at 3 mV s⁻¹. In comparison, that for the “TeO₂+ZnI₂” cathode starts from 11.1% at 0.5 mV s⁻¹ to 23.5% at 3 mV s⁻¹ due to weak adsorption of active elements at a high scan rate (FIG. 16B).

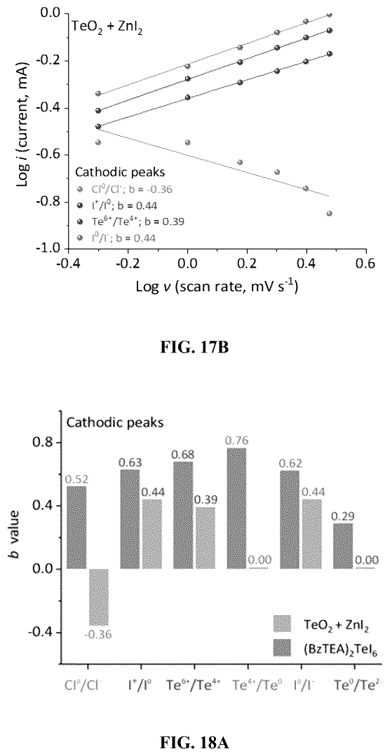

Referring to FIG. 17A, the derived b value for each cathodic peak typically ranges from 0.5 to 1.0, indicating a combined contribution of faradaic and capacitive processes during the conversion reactions. However, the b values of the control sample are far below 0.5 and turned negative for Cl⁰/Cl⁻, suggesting the poor cycling stability of the “TeO₂+ZnI₂” cathode and uncontrolled loss of chlorine elements (FIGS. 16B, 17B).

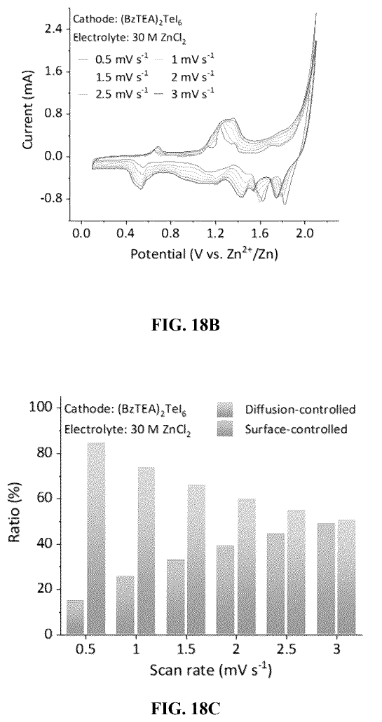

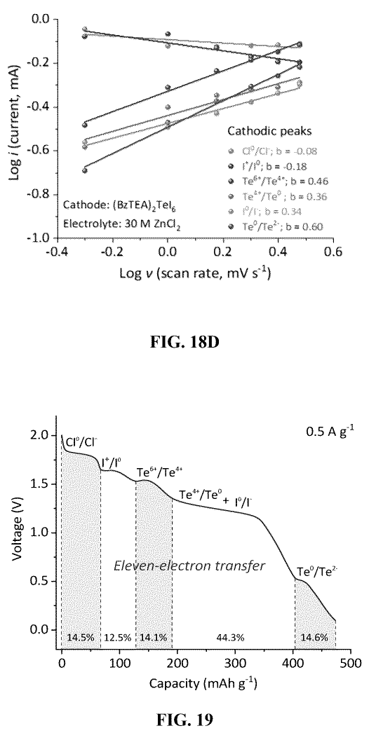

The summary in FIG. 18A demonstrates their difference in b values. It highlights the importance of (BzTEA)₂TeI₆ and ChCl for properly operating batteries, aside from taking full advantage of the B-site tellurium elements. As a comparison, the Zn∥(BzTEA)₂TeI₆ battery in 30 M ZnCl₂ experiences severe degradation under identical test conditions, even though it delivers a Te⁰/Te²⁻ redox pair with a larger b value (0.6) and a mild Te⁶⁺/Te⁴⁺ redox pair (FIGS. 18B-18D).

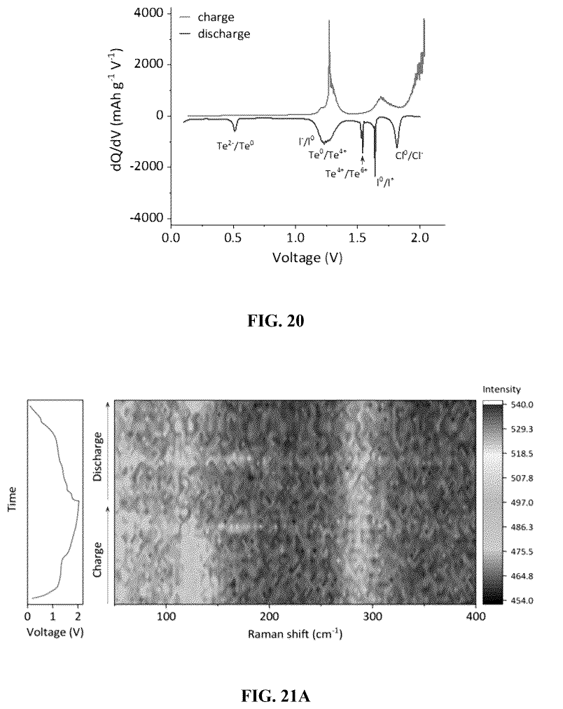

FIG. 19 shows a typical galvanostatic discharge curve of the Zn∥(BzTEA)₂TeI₆ battery at 0.5 A g⁻¹, revealing an eleven-electron transfer process. This includes a three-electron transfer from iodine, an eight-electron transfer from tellurium, and one electron from chlorine, consistent with the results from the differential capacity (dQ/dV) plot in FIG. 20.

### Example 4

### Mechanism of the Eleven-Electron Transfer

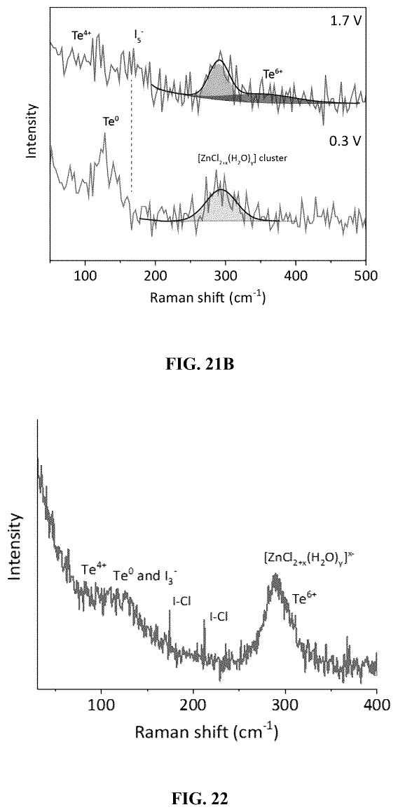

FIGS. 21A-21B show the in situ Raman spectra recorded during the charge and discharge process, which semi-qualitatively indicate the presence of I₅⁻ at 169 cm⁻¹, Te⁰ at 119 cm⁻¹, Te⁴⁺ at 70 cm⁻¹, and Te⁶⁺ is possibly hidden inside the tail of [ZnCl₂₊ₓ(H₂O)_{y}] cluster (approximately 300 cm⁻¹).

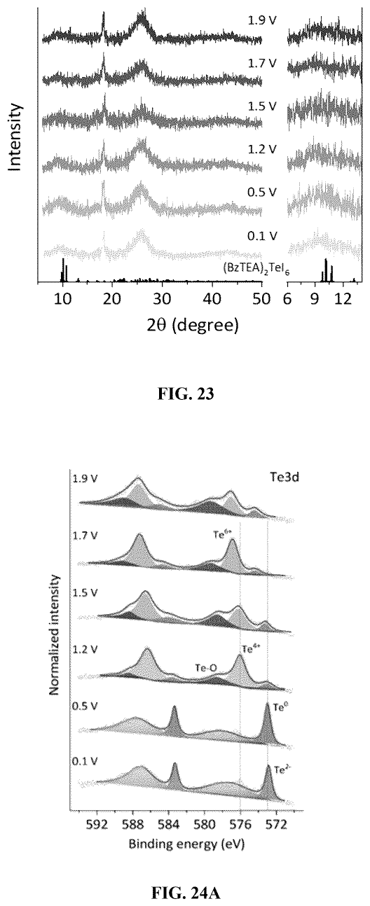

Referring to FIG. 22, Raman study of the charged separator further reveals the appearance of I—Cl at around 210 cm⁻¹ and intermediate I₃⁻ at around 111 cm⁻¹. The XRD and its enlarged patterns in FIG. 23 demonstrate that the (BzTEA)₂TeI₆ retains its crystallographic preferred orientation at round 10° during the whole cycling process.

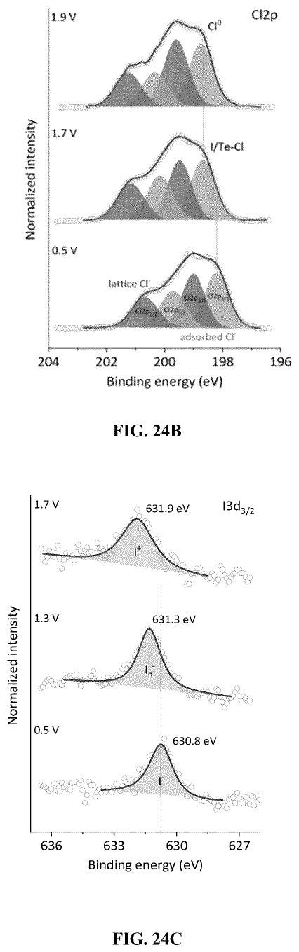

X-ray photoelectron spectroscopy (XPS) measurements are further performed to evaluate the perovskite cathode's conversion reactions. As demonstrated in FIG. 24A, Te⁰ and Te²⁻ dominate at discharge states; the signal of Te⁴⁺ first appears at 576 eV when charged to 1.2 V and shifts to 576.9 eV, verifying the formation of Te⁶⁺. The presence of Te—O at 579.2 eV is attributed to the oxidation of high-valent tellurium ions in damp air. The Cl2p_{3/2} core level spectra in FIG. 24B exhibits the signals from lattice Cl⁻ changing from 198.9 eV at 0.5 eV, 199.4 eV at 1.7 V, to 199.6 eV at 1.9 V, contributing to an energy span of over 0.7 eV. Instead, the adsorbed Cl⁻ changes from 198.2 eV at 0.5 V to 198.7 eV at 1.7 V and slightly increases to 198.73 eV at 1.9 V, corresponding to an energy change of 0.5 eV. The energy evolution of the two types of Cl⁻ reveals that a certain degree of (dynamic) halide exchange between iodide and chloride ions can promote a reliable Cl⁰/Cl⁻ redox reaction, consistent with the CV performance discussed above. The I3d_{3/2} core level spectra in FIG. 24C demonstrates the conversion from I⁺ at 1.7 V, to I⁰ at 1.3 V and I⁻ at 0.5 V, verifying the successful operation of the I⁺/I₀/I⁻ redox pairs.

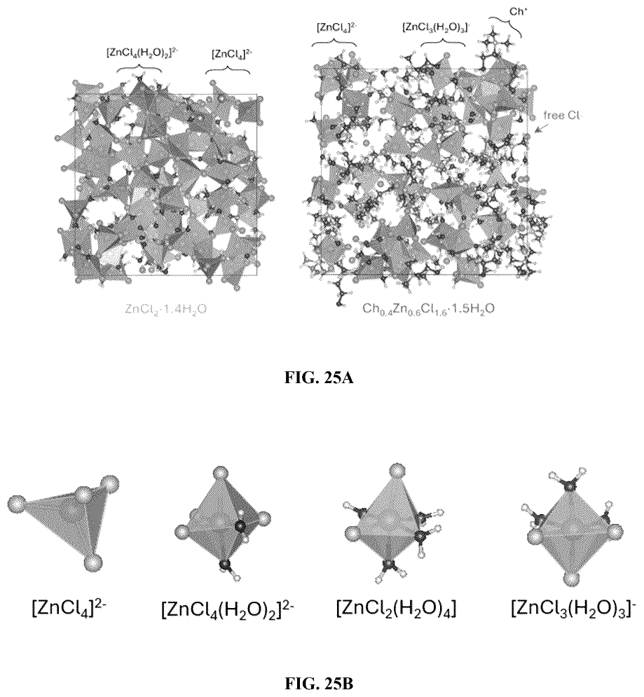

MD simulations and DFT calculations are subsequently conducted to understand the working principle of the chalcogen halide perovskite cathode. As depicted in FIG. 25A, the ZnCl₂·1.4H₂O electrolyte is dominated by tetrahedral [ZnCl₄]²⁻ and octahedral [ZnCl₄ (H₂O)₂]²⁻ clusters. Notably, as the inclusion of ChCl, the coordinated water molecules surrounding Zn²⁺ increase in the form of [ZnCl₃(H₂O)₃]⁻ and octahedral [ZnCl₂ (H₂O)₄] cluster, giving rise to the free Cl⁻ radicals that sat in the electrolyte voids (FIG. 25B).

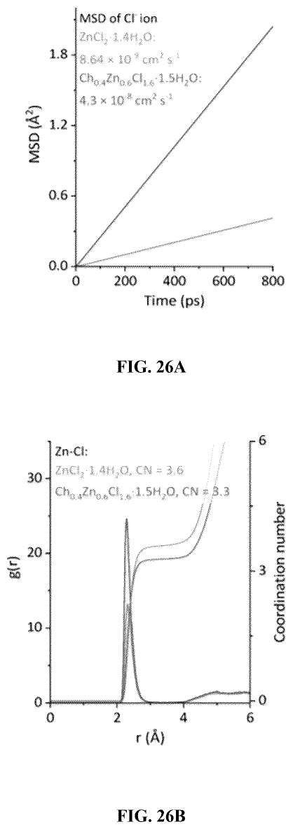

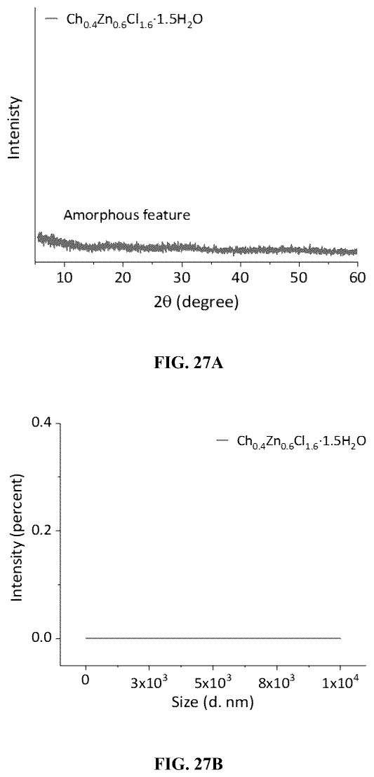

The mean squared displacement (MSD) study in FIG. 26A proves a much higher mobility of Cl⁻ ion in Ch_{0.4}Zn_{0.6}Cl_{1.6}·1.5H₂O (4.30×10⁻⁸ cm² s⁻¹) while that for ZnCl₂·1.4H₂O is 8.64×10⁻⁹ cm² s⁻¹. The radial distribution function (RDF) result in FIG. 26B confirms that the coordination number of Cl⁻ decreases from 3.6 to 3.3 after introducing ChCl. Moreover, the amorphous features of Ch_{0.4}Zn_{0.6}Cl_{1.6}·1.5H₂O and the absence of undissolved solutes emphasize that the designed electrolyte is a homogeneous solution (FIGS. 27A-27B), which offers high Cl⁻ mobility to compensate and stabilize high-valent tellurium ions. Of note, the (BzTEA)₂TeI₆ perovskite surface synergistically provides a fast channel for transporting Cl⁻ ions, favoring the stabilization of high-valent tellurium ions.

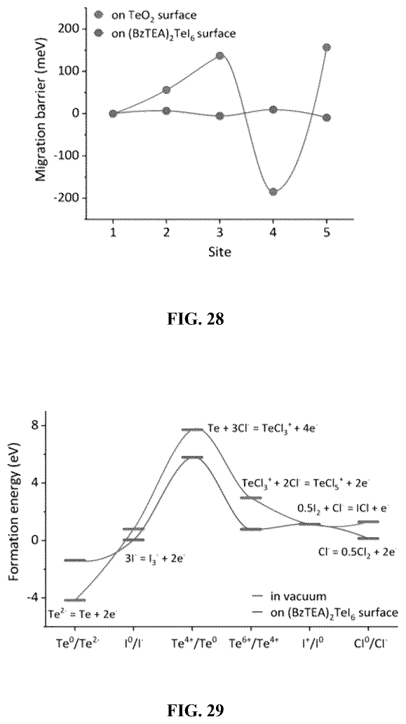

As shown in FIG. 28, the migration energy of Cl⁻ along the (1 0 −1) lattice plane of perovskite oscillates from −9.5 to 9.6 eV. In contrast, the amplitude of the migration barrier on TeO₂ rises to over 156 eV.

In addition to kinetic influences, the conversion reactions on the (BzTEA)₂TeI₆ surface are thermodynamically preferred. Specifically, as demonstrated in FIG. 29, the formation energy of critical chalcogen- and halogen-related redox reactions all decrease, especially for TeCl₃⁺ and TeCl₅⁺, which drop from 7.7 eV to 5.8 eV and from 3.0 eV to 0.8 eV, respectively.

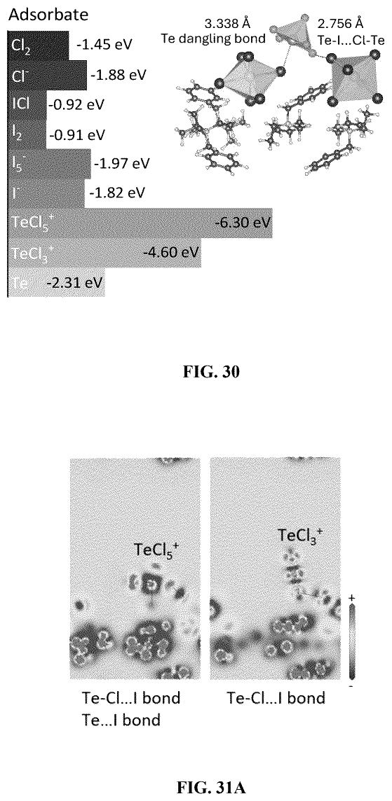

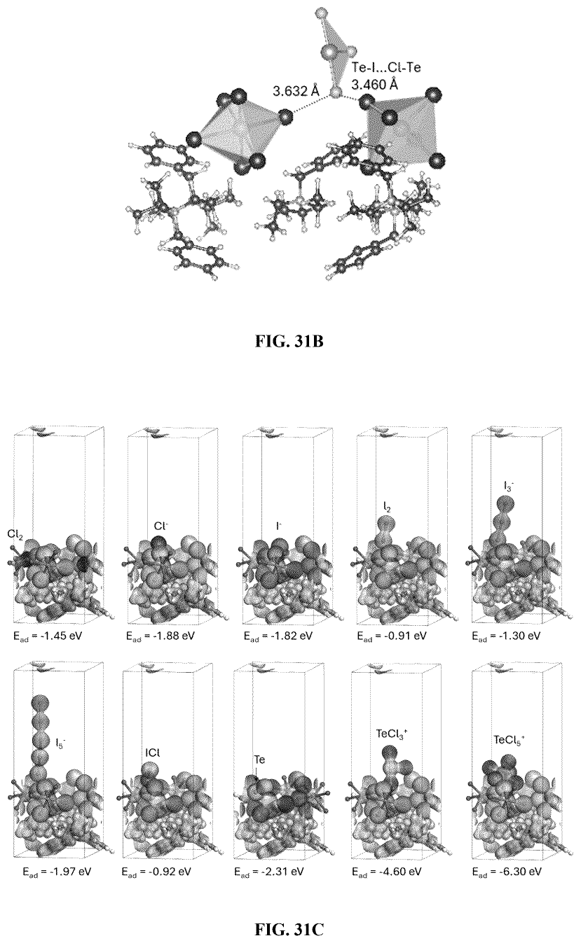

Besides, the presence of the perovskite surface enhances the confinement ability of chalcogen and halogen elements through halogen bonds (such as Te—I . . . Cl—Te and Te—I . . . I) and positive dangling bonds, as summarized in FIG. 30. The effective coordination between the perovskite surface, high-valent cations, and passivating Cl⁻ ligands collectively favors their stabilization and the associated redox reactions (FIGS. 31A-31B). The more significant adsorption energy of I₅⁻ (−1.97 eV) than I₃⁻ (−1.30 eV) helps explain the proliferation of I₅⁻ during the charging process, pointing out improved reaction kinetics and suppressed shuttle effects (FIG. 31C).

### Example 5

Electrochemical Performance of Zn∥(BzTEA)₂TeI₆ Battery

Subsequently, batteries are assembled to examine the practical performance of the perovskite cathode in the Ch_{0.4}Zn_{0.6}Cl_{1.6}·1.5H₂O electrolyte.

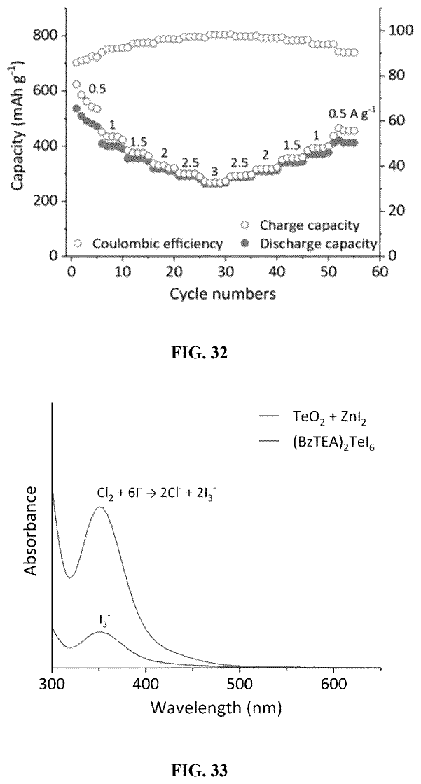

As presented in FIG. 32, the Zn∥(BzTEA)₂TeI₆ battery delivers a steady capacity of 473 mAh g⁻¹_{Te/I} at 0.5 A g⁻¹ and 258 mAh g⁻¹_{Te/I} at 3 A g⁻¹, which reverts to 411 mAh g⁻¹_{Te/I} after current reset, showing a high capacity retention of 87%. The relatively lower coulombic efficiency (CE) at lower C-rates may be attributed to the loss of chlorine gas during the slow charge/discharge process (FIG. 33). This loss is suppressed at higher C-rates due to the shorter cycle time and saturated Cl₂ dissolution in the electrolytes.

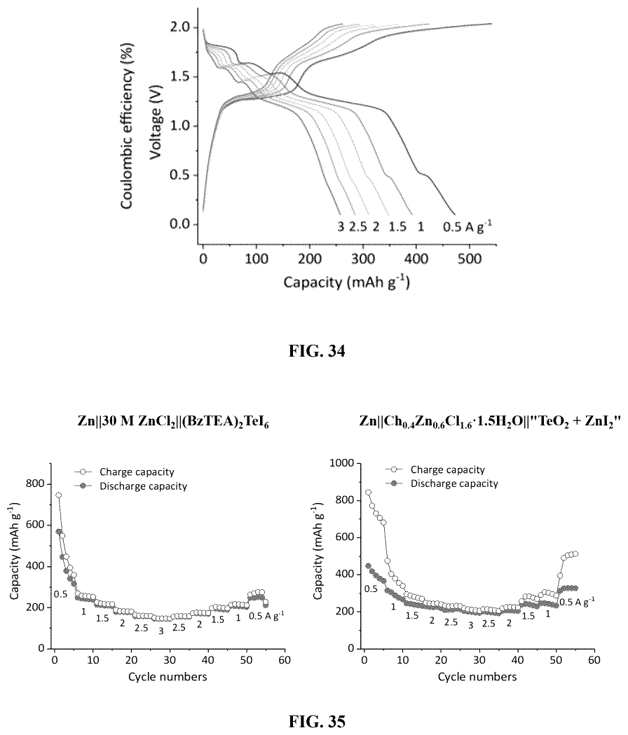

The corresponding galvanostatic charge-discharge (GCD) curves in FIG. 34 show five stable discharge plateaus at 1.81 V (for Cl⁰/Cl⁻), 1.64 V (for I⁺/I⁰), 1.53 V (for Te⁶⁺/Te⁴⁺), 1.26 V (for overlayed Te⁴⁺/Te⁰ and I⁰/I⁻), and 0.51 V (for Te⁰/Te²⁻), outperforming the Zn∥Ch_{0.4}Zn_{0.6}Cl_{1.6}·1.5H₂O∥“TeO₂+ZnI₂” and Zn∥30 M ZnCl₂∥(BzTEA)₂TeI₆ batteries (FIG. 35).

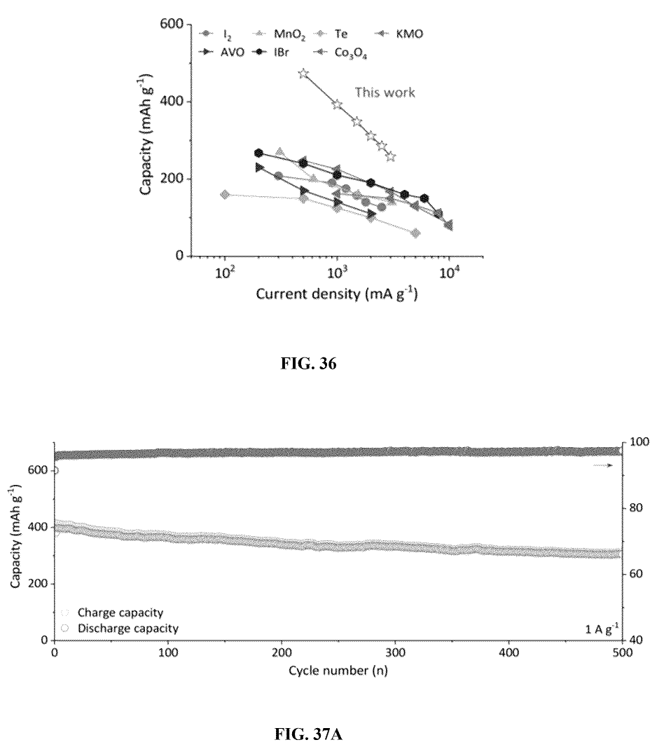

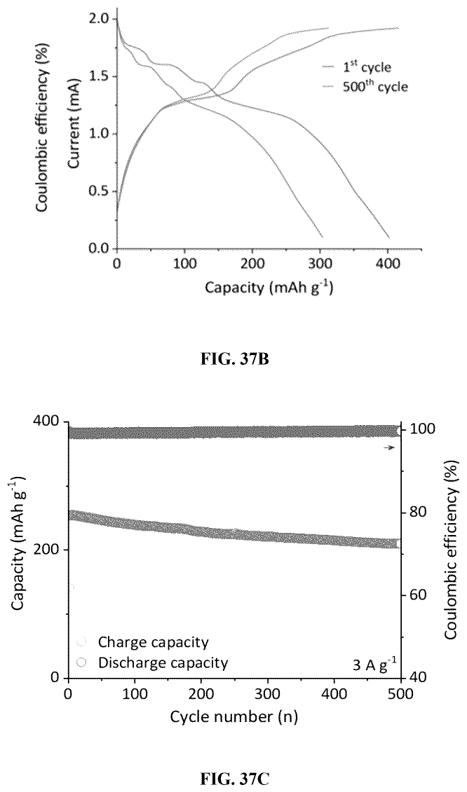

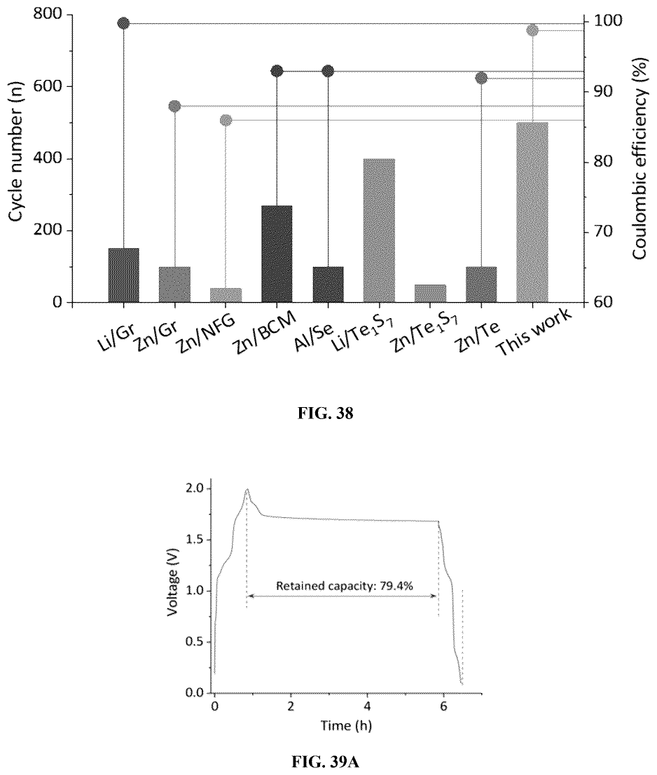

The highly reversible chalcogen- and halogen-related redox reactions jointly contribute to an eleven-electron transfer mode and verify the feasibility of the organic-inorganic hybrid tellurium iodide perovskite cathode. FIG. 36 highlights the advantages of the (BzTEA)₂TeI₆ perovskite cathode offering a record capacity compared with related references⁷⁻¹⁵. Long-term cycling performance is provided in FIGS. 37A-37C. The Zn∥(BzTEA)₂TeI₆ battery successfully cycles 500 times at 1 A g⁻¹ and 3 A g⁻¹ with a high CE of approaching 98% and capacity retention of over 77% and 82%, respectively, superior to the reported counterparts (FIG. 38).

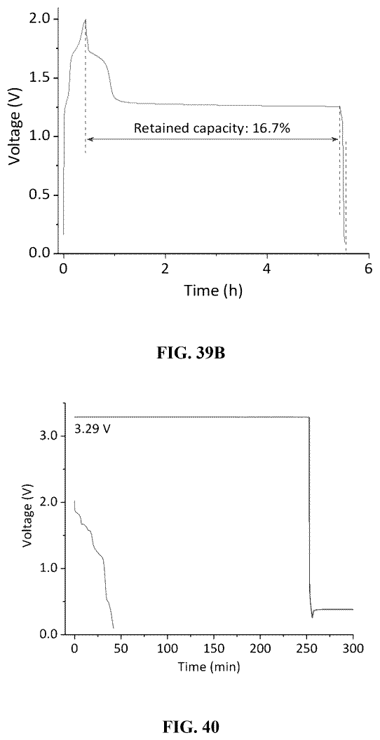

Moreover, the Zn∥(BzTEA)₂TeI₆ battery retains 79.4% of its initial capacity after a storage period of 5 hours due to the suppressed shuttle effect, while that for the Zn∥“TeO₂+I₂” battery is down to 16.7% (FIGS. 39A-39B).

The viability of the Zn∥(BzTEA)ₑTeI₆ battery is additionally confirmed using a DC-DC converter, which maintains a consistent voltage output of 3.29 V for more than 250 min (FIG. 40).

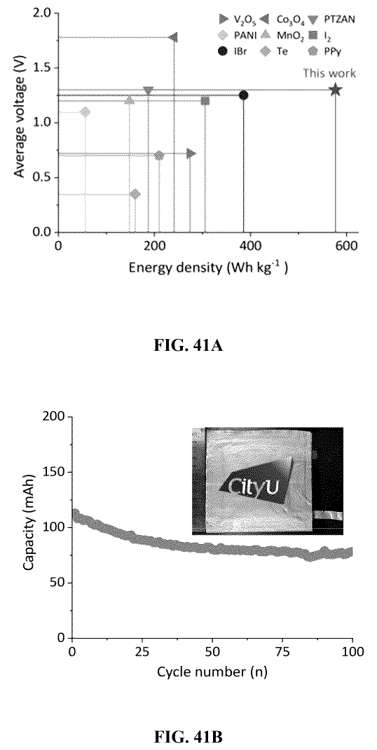

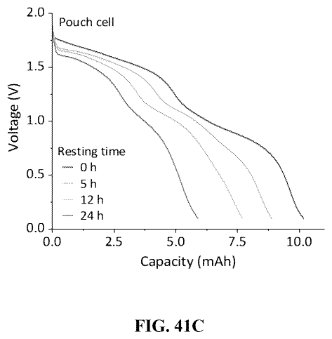

As a summary, FIG. 41A emphasizes the importance of the novel eleven-electron transfer mode actualized by the perovskite cathode and proper electrolyte design. The structural advance endows the zinc ion batteries with a high average voltage of 1.3 V and a large energy density of over 577 Wh kg⁻¹_{Te/I}. The pouch cell based on the (BzTEA)₂TeI₆ perovskite cathode further gives a high capacity of 113 mAh (at 10 mA cm⁻²) with a capacity retention of over 66% after 100 cycles (FIG. 41B). The pouch cell also presents good storage stability with a capacity loss of less than 24% after a resting time of 12 hours (FIG. 41C).

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “low-dimensional tellurium iodide perovskite” refers to a specialized crystal structure where tellurium and iodide atoms form a perovskite framework with reduced dimensionality, such as 1D or 2D arrangements. These low-dimensional structures exhibit unique electronic and ionic properties, enhancing stability and performance in energy storage applications, like batteries, by confining ionic movement and facilitating reversible redox processes.

The term “multi-electron redox reactions” involve the simultaneous transfer of multiple electrons during a single redox process. In the context of this invention, such reactions allow both chalcogen and halogen elements within the perovskite to undergo electron gain or loss, thus enabling greater charge storage capacity and enhancing battery performance.

Ther term “shuttle effect” refers to the undesirable transport of ions, particularly halide or chalcogen ions, back and forth between electrodes in a battery. This phenomenon can lead to inefficient charge/discharge cycles and reduced battery life by causing self-discharge and capacity fade. In this invention, the perovskite structure is designed to minimize the shuttle effect by spatially confining active elements.

Ther term “eleven-electron transfer process” describes a highly efficient electrochemical mechanism where a sequence of redox pairs (e.g., Cl⁰/Cl⁻, I⁺/I⁰/I⁻, Te⁶⁺/Te⁴⁺/Te⁰/Te²⁻) enables the transfer of up to eleven electrons per cycle. This extended redox activity supports high energy density and increased capacity retention in battery applications.

The term “electrochemical inertness of B-site cations” refers to the tendency of certain cations, positioned at the “B” site within a perovskite lattice, to resist redox reactions, thereby limiting their contribution to charge storage. This property can reduce overall battery capacity. The invention addresses this by replacing these inert cations with more electrochemically active chalcogen cations to enhance battery performance.

The term “spatial confinement of active elements” is a design strategy in which the active ions, such as halogen and chalcogen elements, are contained within specific regions of the perovskite structure. This confinement helps prevent ion crossover, reduces the shuttle effect, and improves overall stability and efficiency by controlling the movement of active species within the battery.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### REFERENCES: THE DISCLOSURES OF THE FOLLOWING REFERENCES ARE INCORPORATED BY REFERENCE

1. Wang, S. et al. Strongly Luminescent Dion-Jacobson Tin Bromide Perovskite Microcrystals Induced by Molecular Proton Donors Chloroform and Dichloromethane. Adv. Funct. Mater. 31, 2102182 (2021).
2. Wang, S., Kershaw, S. V. & Rogach, A. L. Bright and Stable Dion-Jacobson Tin Bromide Perovskite Microcrystals Realized by Primary Alcohol Dopants. Chem. Mater. 33, 5413-5421 (2021).
3. Qi, J., Wang, S., Portniagin, A., Kershaw, S. V. & Rogach, A. L. Room Temperature Fabrication of Stable, Strongly Luminescent Dion-Jacobson Tin Bromide Perovskite Microcrystals Achieved through Use of Primary Alcohols. Nanomater. 11, 2738 (2021).
4. Sun, J.-K. et al. Polar Solvent Induced Lattice Distortion of Cubic CsPbI₃ Nanocubes and Hierarchical Self-Assembly into Orthorhombic Single-Crystalline Nanowires. J. Am. Chem. Soc. 140, 11705-11715 (2018).
5. Zhang, L. & Hou, Y. The Rise and Development of MOF-Based Materials for Metal-Chalcogen Batteries: Current Status, Challenges, and Prospects. Adv. Energy Mater. 13, 2204378 (2023).
6. Zhang, L. & Liu, Y. Aqueous Zinc-Chalcogen Batteries: Emerging Conversion-Type Energy Storage Systems. Batteries 9, 62 (2023).
7. Wang, F. et al. Fully Conjugated Phthalocyanine Copper Metal-Organic Frameworks for Sodium-Iodine Batteries with Long-Time-Cycling Durability. Adv. Mater. 32, e1905361 (2020).
8. Sun, P. et al. Simultaneous Regulation on Solvation Shell and Electrode Interface for Dendrite-Free Zn Ion Batteries Achieved by a Low-Cost Glucose Additive. Angew Chem. Int. Ed. 60, 18247-18255 (2021).
9. Li, S. et al. Design and Synthesis of a pi-Conjugated N-Heteroaromatic Material for Aqueous Zinc-Organic Batteries with Ultrahigh Rate and Extremely Long Life. Adv. Mater. 35, e2207115 (2023).
10. Chen, Z. et al. Conversion-Type Nonmetal Elemental Tellurium Anode with High Utilization for Mild/Alkaline Zinc Batteries. Adv. Mater. 33, e2105426 (2021).
11. Zheng, Z., Guo, S., Yan, M., Luo, Y. & Cao, F. A Functional Janus Ag Nanowires/Bacterial Cellulose Separator for High-Performance Dendrite-Free Zinc Anode Under Harsh Conditions. Adv. Mater. 35, e2304667 (2023).
12. Sun, Q. et al. Silver Ion in Combination Intercalation/Deintercalation Reaction of Aqueous Zinc-Ion Batteries. J. Mater. Sci. 58, 12008-12019 (2023).
13. Chen, S. et al. Solid Interhalogen Compounds with Effective Br⁰ Fixing for Stable High-energy Zinc Batteries. Angew Chem. Int. Ed. 62, e202301467 (2023).
14. Wang, X. et al. An Aqueous Rechargeable Zn//Co₃O₄ Battery with High Energy Density and Good Cycling Behavior. Adv. Mater. 28, 4904-4911 (2016).
15. Zhang, N. et al. Rechargeable Aqueous Zn—V₂O₅ Battery with High Energy Density and Long Cycle Life. ACS Energy Lett. 3, 1366-1372 (2018).

What is claimed is:

1. A low-dimensional tellurium iodide perovskite structure, comprising an inorganic-organic hybrid material, wherein the low-dimensional tellurium iodide perovskite structure enables multi-electron redox reactions involving chalcogen and halogen elements, achieving an eleven-electron transfer process including redox pairs of Cl⁰/Cl⁻, I⁺/I⁰/I⁻, and Te⁶⁺/Te⁴⁺/Te⁰/Te²⁻, and wherein the low-dimensional tellurium iodide perovskite structure confines the chalcogen and halogen elements, thereby reducing ion crossover.

2. The low-dimensional tellurium iodide perovskite structure of claim 1, wherein the inorganic-organic hybrid material comprises an organic-inorganic hybrid chalcogen halide perovskite.

3. The low-dimensional tellurium iodide perovskite structure of claim 2, wherein the organic-inorganic hybrid chalcogen halide perovskite comprises a benzyltriethylammonium tellurium iodide ((BzTEA)₂TeI₆) framework.

4. The low-dimensional tellurium iodide perovskite structure of claim 3, wherein the tellurium serves as a multi-valent B-site cation, achieving a high coulombic efficiency approaching 98% while coupled with designed battery configuration.

5. The low-dimensional tellurium iodide perovskite structure of claim 1, wherein the inorganic-organic hybrid material is synthesized by a saturated recrystallization process, utilizing tellurium oxide and benzyltriethylammonium chloride in an aqueous medium.

6. The low-dimensional tellurium iodide perovskite structure of claim 1, wherein the structure achieves a discharge capacity of at least 450 mAh g⁻¹_{Te/I} and an energy density of 550-600 Wh kg⁻¹_{Te/I} at a current density of 0.5 A g⁻¹.

7. An aqueous zinc battery, comprising:
a cathode comprising a cathode material;
a zinc anode;
an aqueous electrolyte, wherein the aqueous electrolyte enables high chloride ion mobility and supports reversible redox reactions of chalcogen and halogen elements in the cathode; and
a separator, wherein the cathode and zinc anode are positioned on opposite sides of the separator, the aqueous electrolyte fills the internal space around the cathode, the anode, and the separator,
wherein the aqueous zinc battery exhibits a capacity retention rate of at least 77% after 500 cycles at a current density of 1 A g⁻¹.

8. The aqueous zinc battery of claim 7, wherein the cathode material comprises an inorganic-organic hybrid material including an organic-inorganic hybrid chalcogen halide perovskite, the organic-inorganic hybrid chalcogen halide perovskite enables multi-electron redox reactions involving chalcogen and halogen elements, achieving an eleven-electron transfer process including redox pairs of Cl⁰/Cl⁻, I⁺/I⁰/I⁻, and Te⁶⁺/Te⁴⁺/Te⁰/Te²⁻.

9. The aqueous zinc battery of claim 8, wherein the organic-inorganic hybrid chalcogen halide perovskite confines the chalcogen and halogen elements, thereby reducing ion crossover.

10. The aqueous zinc battery of claim 8, wherein the organic-inorganic hybrid chalcogen halide perovskite comprises a benzyltriethylammonium tellurium iodide ((BzTEA)₂TeI₆) framework.

11. The aqueous zinc battery of claim 10, wherein the tellurium serves as a multi-valent B-site cation, contributing to an eight electron transfer process from Te²⁻ to Te⁰, Te⁴⁺, and Te⁶⁺ within the framework by stabilizing high-valent tellurium ions through interaction with chloride ions in the aqueous electrolyte.

12. The aqueous zinc battery of claim 7, wherein the cathode further comprises a current collector, one or more electrically conductive particles, or a binder.

13. The aqueous zinc battery of claim 12, wherein the current collector comprises one selected from the group consisting of carbon cloth, carbon paper, graphite paper, Ti foil/mesh, and stainless steel that are compatible with the cathode material.

14. The aqueous zinc battery of claim 7, wherein the zinc anode comprises zinc plate, zinc powder or zinc foil.

15. The aqueous zinc battery of claim 7, wherein the aqueous electrolyte comprises zinc slats and choline chloride as a solute.

16. The aqueous zinc battery of claim 15, wherein the electrolyte comprises zinc chloride and choline chloride, delivering an average discharge voltage of approximately 1.3 V through multiple redox pairs.

17. The aqueous zinc battery of claim 7, wherein the aqueous electrolyte comprises Ch_{0.4}Zn_{0.6}Cl_{1.6}·nH₂O, where 1.45≤n≤1.55.

18. The aqueous zinc battery of claim 7, wherein the aqueous zinc battery is further configured as a pouch cell, providing a capacity of at least 113 mAh and retaining over 66% capacity after 100 cycles.

19. The aqueous zinc battery of claim 7, wherein the separator comprises glass fibers, polymer films, and nonwoven fibers.
